(19) United States
(12) Patent Application Publication
(10) Pub. No.: US 2012/0036073 A1
(43) Pub. Date: Feb. 9, 2012

(54) INTELLIGENT ESTIMATES IN AUTHORIZATION

(76) Inventors: Gourab Basu, Half Moon Bay, CA (US); Shaun Bodington, Montara, CA (US); Ross Sakata, Foster City, CA (US); Michael Mori, San Mateo, CA (US)

(21) Appl. No.: 13/188,045

(22) Filed: Jul. 21, 2011

Related U.S. Application Data
(60) Provisional application No. 61/370,416, filed on Aug. 3, 2010.

(51) Int. Cl. G06Q 40/00

(52) U.S. Cl. 705/44

(57) ABSTRACT

Techniques for providing an intelligent estimated amount for authorization include receiving a request to calculate an estimated amount for a transaction where the final amount is not known at the time of authorization. A payment processing network calculates the estimated amount based on several factors associated with the transaction and provides the estimated amount to an issuer for authorization.

### CROSS REFERENCES TO RELATED APPLICATIONS

The present application claims benefit under 35 U.S.C. §119(e) of U.S. Provisional Patent Application No. 61/370,416 filed on Aug. 3, 2010, the contents of which are incorporated by reference herein in their entirety for all purposes.

### BACKGROUND

Traditionally, when a user provides his payment device, e.g., a credit card or a debit card, to pay for a transaction, the user is aware of the final amount for the transaction. Once the payment device is presented to an access device, e.g., a POS device, at a merchant, the payment card details are captured by the access device and provided to the issuer of the payment device along with the amount for the transaction, via a payment processing network, for approval of the transaction amount. The user has enough balance in his account to cover for the transaction, the amount is approved and the transaction is completed.

In certain situations, the final amount for the transaction is not known before the user presents his payment device to the merchant, e.g., when a user purchases gas at a gas station. In these instances, the merchant estimates an amount for the transaction and submits the estimated amount to the issuer of the payment device for authorization. The issuer then authorizes or denies the amount based on the balance in the user account. Currently, there are two ways in which the merchants request such authorization.

In one instance, the merchant requests authorization for $1 for a transaction. The payment processing network, e.g., VisaNet, that processes the transaction and sends the $1 to the issuer. The amount of $1 implies that the merchant is seeking authorization for a default amount, e.g., $75, that has been negotiated between the issuer and the payment processing network. The issuer may then approve or deny authorization for the default amount. The user is then free to spend up to the default amount, if approved, for that transaction.

In another instance, the merchant may estimate an amount based on information available to the merchant. For instance, if the merchant is a gas station operator, the merchant may estimate an amount based on the current price of gasoline on the day of transaction and an average fuel tank capacity. For example, if the price of unleaded 87 octane gas on a particular day is $4/gallon and if the merchant estimates and average fuel tank with 10 gallon capacity, the merchant may request authorization for $40 from the issuer of the payment device. In some embodiments, the merchant may arbitrarily choose an amount for seeking authorization.

Both methods discussed above have many disadvantages associated with them. First, if the user's account has a credit balance that is less than the default amount or the estimated amount, the authorization may be denied resulting in potential loss of business for the merchant. Second, consider that the user actually needs $150 worth of gas since he/she drives a big SUV such as a Hummer. In this instance, if the merchant estimates $40 as discussed above or chooses the default amount $75, the fuel dispenser will shut off before the user has completely filled the tank. In some embodiments, the user may not be inclined to indulge in a second transaction to finish filling up the gas tank. This may result in a potential sales loss of $110-$75 to the merchant. If the merchant overestimates the amount, he runs the risk of authorization denial, which may cause the user to abandon his transaction again resulting in potential loss of business.

In some embodiments, the merchant can allow the user to charge more than the authorized amount in order to complete the sale. For example, the merchant seeks authorization for $40 but lets the customer dispense $50 worth of gasoline to fill his tank. However, in this instance, the merchant runs the risk of getting a chargeback for $10 from the issuer since the issuer had previously only authorized $40. Thus, another disadvantage of the current methods is the risk for the merchant for a potential charge back.

What is needed is a more robust and accurate method for estimating an amount for transactions where the final amount is not known when the authorization is requested.

### BRIEF SUMMARY

Embodiments of the invention provide systems and methods for performing intelligent estimates for authorization requests. In some transactions, it is not possible to know the amount of the final transaction at the time authorization for the transaction is requested. Embodiments of the invention use available data, including transaction history, to intelligently estimate the final amount of the transaction for authorization purposes, even though the actual final amount is not known.

Some embodiments of the present invention provide a computer server for determine intelligent estimated amount. The computer server includes a processor and a memory coupled with the processor. The process can receive an authorization request message for a transaction from a merchant computer associated with a merchant. The transaction may be such that a final amount associated with the transaction is not known at time that the authorization request message is received by the computer server. The authorization request message may include information about a payment device and a request to calculate an estimated amount for the transaction. Thereafter, the computer server can determine the estimated amount for the transaction based at least in part on the information about the payment device and one or more items of information related to the transaction and include the estimated amount in the authorization request message. The authorization request message including the estimated amount can be then communicated to an issuer computer.

In some embodiments, the computer server may also receive an authorization response message from the issuer computer indicative of whether the estimated amount was approved or denied and communicate the authorization response message to the merchant computer if the estimated amount is approved. In some embodiments, the authorization response message may include the estimated amount.

In some embodiments, the one or more items of information related to the transaction described above may comprise one or more of: an average amount spent using the payment device at the merchant, location of the merchant, price of an item or service that is subject of the transaction, type of the item or service, or amount of money spent previously by a user associated with the payment device for purchase of the type of item or service.

In some embodiments, the transaction described above may include purchasing fuel. In this embodiment, the computer server may determine a type of fuel previously purchased by a user, determine a location for the fuel purchase transaction, determine a current price of the type of fuel based on the location, determine an average amount of the type of fuel purchased by the user in one or more previous transactions, determine an account balance associated with the payment device, and determine the estimated amount based at least in part on the type of fuel, the location, the current price, and the average amount.

Some embodiments of the present invention provide a method performed by a server computer. The method may include receiving a request for authorizing a transaction from a merchant computer in which a final amount associated with the transaction is not known. In some embodiments, the request may include information about a payment device associated with a user. The method may further include determining an estimated amount for the transaction based at least in part on the information about the payment device and communicating the estimated amount to an issuer computer for authorization. Thereafter the method may also include receiving an authorization response from the issuer that is indicative of whether the estimated amount was approved or denied and sending the authorization response including the estimated amount to the merchant computer if the estimated amount is approved.

The method may also include using certain user-related attributes in order to determine the estimated amount. In some embodiments, the attributes may include an average amount previously spent by the user for a previous transaction similar to the current transaction, details of an item or service purchased by the user as part of the previous transaction similar to the current transaction, and time period between the transaction and the previous transaction similar to the current transaction when the previous transaction immediately precedes the transaction.

In some embodiments where the transaction is a fuel purchase transaction, determining the estimated amount may further include analyzing a merchant identifier associated with a merchant operating the automated fuel dispenser to determine the name of the merchant, determining a geographical location of the automated fuel dispenser, determining a type of fuel most frequently purchased using the payment device, determining a current price for the type of fuel, and determining an average amount of fuel purchased in each of a plurality of previous transactions using the one or more automated fuel dispensers. The method may then include determining the estimated amount based at least in part on the name of the merchant, the geographical location of the automated fuel dispenser, the type of fuel, the current price for the type of fuel, and the average amount of fuel purchase. In some embodiments, the merchant may include merchant-specific parameters that may also be used to determine the estimated amount.

Certain embodiments of the present invention provide a non-transitory computer-readable medium that includes a plurality of instructions for controlling a processor to determine an estimated amount for a transaction. The plurality of instructions may comprise instructions that cause the processor to receive an authorization request for the transaction from a merchant computer including information about the transaction and an indication for estimating an amount for the transaction. The transaction may be such that a final amount for the transaction is not known at the time of receipt of the authorization request. The computer-readable medium may further include instructions that cause the processor to determine an estimated amount for the transaction based at least in part on the information included in the authorization request and one or more items of information related to the transaction, instructions that cause the processor to send the estimated amount to an issuer computer for authorization, instructions that cause the processor to receive an authorization response message from the issuer computer indicating whether the estimated amount was approved or denied, and instructions that cause the processor to communicate the approval to the merchant computer if the estimated amount is authorized.

In some embodiments, the computer-readable medium may also include instructions that cause the processor to determine name of the merchant based on a merchant identifier included in the authorization request, instructions that cause the processor to determine an item or service associated with the transaction, instructions that cause the processor to determine a geographical location of the merchant, instructions that cause the processor to determine an average price for the item or service in the geographical location, instructions that cause the processor to determine a first average amount previously spent by the user for that item or service, instructions that cause the processor to determine a second average amount previously spent by the user for that item or service using the payment device, and instructions that cause the processor to determine the estimated amount based at least in part on the geographical location of the merchant, the average price for the item or service in the geographical location, the first average amount, and the second average amount.

In one embodiment where the transaction is a fuel purchase transaction, the computer-readable medium may include instructions that cause the processor to determine location of the automated fuel dispenser that is being used to dispense the fuel, instructions that cause the processor to determine a type of fuel usually purchased by a user of a payment device being used for the transaction, instructions that cause the processor to determine a current price for the type of fuel, instructions that cause the processor to determine an average amount of the type of fuel purchased by the user in one or more previous transactions, instructions that cause the processor to determine an account balance associated with a payment device being used for the transaction, and instructions that cause the processor to determine the estimated amount based at least in part on the location of the automated fuel dispenser, the type of fuel, the current price for the type of fuel, the average amount of the type of fuel purchased by the user, and the account balance.

Some embodiments of the present invention provide an method performed by a issuer computer for determining an authorization amount to be approved regardless of the requested amount. In this embodiment the method may include receiving an authorization request message from a payment processing network server computer. The authorization request message includes user payment account information and a first amount for which authorization is requested. The method may further include determining whether to approve or deny the authorization based on analysis of the user payment account information. In some embodiments, the analysis can include determining a current status of the user payment account, analyzing account history of the user payment account, and determining a current credit balance for the user payment account. The method may further include sending an authorization response message to the payment processing network server computer indicating approval of the authorization request message and including a second amount that was authorized. In some embodiments, the second amount can be same as the first amount. In other embodiments, the second amount can be different from the first amount.

In some embodiments, the authorization request message may originate from a merchant and the merchant can specify a third amount in the authorization request message. In this embodiment, the payment processing network server computer may replace the third amount specified by the merchant by the intelligent estimated amount (e.g., first amount described above) before sending the authorization request message to the issuer.

Some embodiments of the present invention provides a method performed by a payment processing network server computer that may include receiving an authorization request for authorizing a transaction from a merchant computer associated with a merchant. The authorization request does not include an amount associated with the transaction and includes an indication for determining an intelligent estimated amount for the transaction. The method may further include determining that the merchant is registered to request the intelligent estimated amount and thereafter determining an algorithm to be used for determining the intelligent estimated amount based at least in part on a merchant category code (MCC) associated with the merchant that is included in the authorization request. Thereafter, the method may include determining one or more performance parameters associated with the merchant, determining pricing information related to the item that is subject of the transaction, and determining information related to one or more previous transactions associated with a user payment account number that is included in the authorization request. Once these items of information are determined, the method may include determining the intelligent estimated amount, including the intelligent estimated amount as the transaction amount in the authorization request, and sending, the authorization request to an issuer.

In some embodiments, the method may further include providing an indication in the authorization message that the transaction amount is the intelligent estimated amount. In some embodiments, the one or more performance parameters associated with the merchant are determined using a merchant verification value (MVV) associated with the merchant. In other embodiments the one or more performance parameters associated with the merchant may include an average transaction amount for the merchant, type of items sold by the merchant, or average price for an item subject to the transaction.

The following detailed description, together with the accompanying drawings will provide a better understanding of the nature and advantages of the present invention.

### BRIEF DESCRIPTION OF THE DRAWINGS

FIG. 1 illustrates a payment processing transaction flow.

FIG. 2 depicts an exemplary transaction flow using Intelligent Estimates for Authorization according to an embodiment of the present invention.

FIG. 3 is a functional block diagram of a payment processing network server computer according to an embodiment of the present invention.

FIG. 4 illustrates a table showing information that can be stored in the database of a payment processing network server computer according to an embodiment of the present invention.

FIG. 5 illustrates a table showing information that can be stored in the database of a payment processing network server computer according to another embodiment of the present invention.

FIG. 6 illustrates a table showing information that can be stored in the database of a payment processing network server computer according to yet another embodiment of the present invention.

FIG. 7 illustrates an authorization request message according to an embodiment of the present invention.

FIG. 8 is a flow diagram of a process for determining an intelligent estimated amount according to an embodiment of the present invention.

FIG. 9 is a flow diagram of a process for determining an intelligent estimated amount according to another embodiment of the present invention.

FIG. 10 is a high level block diagram of a computer system.

### DETAILED DESCRIPTION

Certain embodiments of the present invention provide techniques for determining an intelligent estimated amount for a transaction amount for inclusion in an authorization request. Specifically, the techniques described herein are useful in instances where a final transaction amount is not known at the time the authorization is requested.

In order to understand the various embodiments in this application, it is first useful to understand the traditional transaction process flow using a payment device.

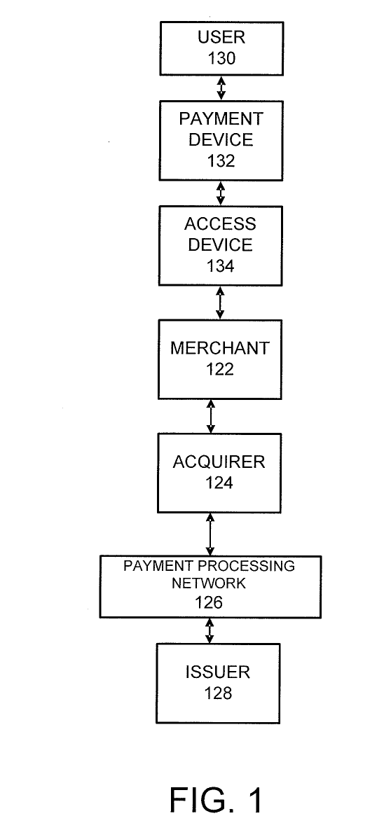

FIG. 1 shows a system 120 for performing a transaction using a payment processing network. The system 120 includes a merchant 122 and an acquirer 124 associated with the merchant 122. In a typical payment transaction, a user 130 may purchase goods or services at the merchant 122 using a payment device 132. The acquirer 124 can communicate with an issuer 128 via a payment processing network 126. The user 130 may be an individual, or an organization such as a business that is capable of purchasing goods or services. The issuer 128 may operate a server computer configured to receive a payment authorization request message from the payment processing network 126 and provide an appropriate reply in the response to the payment authorization request.

The payment device 132 may be in any suitable form. For example, suitable payment devices can be hand-held and compact so that they can fit into a user's wallet and/or pocket (e.g., pocket-sized). They may include smart cards, ordinary credit or debit cards (with a magnetic strip and without a microprocessor), keychain devices (such as the Speedpass™ commercially available from Exxon-Mobil Corp.), etc. Other examples of payment devices include cellular phones, personal digital assistants (PDAs), pagers, payment cards, security cards, access cards, smart media, transponders, and the like. The payment devices can also be debit devices (e.g., a debit card), credit devices (e.g., a credit card), or stored value devices (e.g., a stored value card). In some embodiments, payment device 132 may be in an electronic form such as a digital wallet.

The payment processing network 126 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and in some instances performs clearing and a Base II system, which performs clearing in instances when the VIP system does not perform the clearing.

The payment processing network 126 may include a server computer. A server computer is typically a powerful computer or cluster of computers. For example, the server computer can be a large mainframe, a minicomputer cluster, or a group of servers functioning as a unit. In one example, the server computer may be a database server coupled to a Web server. The payment processing network 126 may use any suitable wired or wireless network, including the Internet.

The merchant 122 may also have, or may receive communications from, an access device 134 that can interact with the payment device 132. The access devices according to embodiments of the invention can be in any suitable form. Examples of access devices include point of sale (POS) devices, Automated Fuel Dispensers (AFDs), cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like.

If the access device 134 is a point of sale terminal, any suitable point of sale terminal may be used including card readers. The card readers may include any suitable contact or contactless mode of operation. For example, exemplary card readers can include RF (radio frequency) antennas, magnetic stripe readers, etc. to interact with the payment devices 132.

In a typical purchase transaction, the user 130 purchases a good or service at the merchant 122 using a payment device 132 such as a credit card. The user's payment device 132 can interact with an access device 134 such as a POS (point of sale) terminal at the merchant 122. For example, the user 130 may take a credit card and may swipe it through an appropriate slot in the POS terminal. Alternatively, the POS terminal may be a contactless reader, and the payment device 132 may be a contactless device such as a contactless card.

An authorization request message is then forwarded to the acquirer 124. After receiving the authorization request message, the authorization request message is then sent to the payment processing network 126. The payment processing network 126 then forwards the authorization request message to the issuer 128 of the payment device 132. The authorization request message includes the exact amount associated with the transaction.

After the issuer 128 receives the authorization request message, the issuer 128 sends an authorization response message back to the payment processing network 126 to indicate whether or not the current transaction (i.e. the amount) is authorized (or not authorized). The transaction processing system 126 then forwards the authorization response message back to the acquirer 124. The acquirer 124 then sends the response message back to the merchant 122.

After the merchant 122 receives the authorization response message, the access device 134 at the merchant 122 may then provide the authorization response message for the user 130. In some embodiments, the authorization response message may include an approval code. The response message may be displayed by the POS terminal, or may be printed out on a receipt.

At the end of the day, a normal clearing and settlement process can be conducted by the transaction processing system 126. A clearing process is a process of exchanging financial details between and acquirer and an issuer to facilitate posting to a user's account and reconciliation of the user's settlement position.

As discussed above, in a traditional transaction process, the authorization request message includes the exact amount for the transaction. The issuer 128 checks to see if the user account has enough credit balance to cover the transaction and based on that approves or denies the transaction.

In some embodiments, the exact amount for the transaction is not known when the authorization request message is sent to the issuer. In this instance, either the merchant or the payment processing network may include an estimated amount for the transaction in the authorization request message. Currently, the estimated amount is determined using one of the two methods discussed above. Some examples of transactions in which the final amount for the transaction may not be known at the time of request for authorization include fuel purchase at an automated fuel dispenser, hotel charges, rental car transactions, etc. Even though the following description may include specific examples of transactions, one skilled in the art will realize that the techniques disclosed herein are applicable to any transaction where the final amount is not known at the time of requesting the authorization.

As described above, a merchant may estimate a fixed amount for a transaction or rely on a default amount specified by the payment processing network, irrespective of the user's preference. The merchant usually has no visibility on the user's spending habits or his account history information and thus any amount specified by the merchant is likely to be erroneous with large deviation from the actual amount of transaction. In some embodiments, the merchant may use $1 as a nominal amount to seek authorization for a fuel purchase transaction. The payment processing network sends the $1 to the issuer for authorization. The issuer upon receiving the $1 may interpret it to imply $75, as described above, and processes the transaction. Thus, the user may be authorized to purchase $75 worth of fuel before the AFD shuts off. However, as described above, using an arbitrary amount such as $75 without much information about the user has its own disadvantages. Embodiments of the present invention provide techniques for intelligently estimating a final transaction price based on a user's uniqueness as well as one or more factors associated with the merchant.

Embodiments of the present invention provide a mechanism for generating intelligent estimated authorization amount for certain transactions and/or in merchant segments where the final amount for the transaction is not known at time of the transaction. Using techniques disclosed below, the payment processing network, such as VisaNet, provided by Visa Inc., may use available information about the user, the user's account, merchant related information, and other factors to determine the estimated amount based on a mathematical model. The information used for estimating the authorization amount can include, but is not limited to, the user's previous payment profile, merchant's payment statistics specific to location and other geographical variations, type of business, the prevalent prices, etc. Based on a variety of such parameters, the payment processing network may modify the merchant's authorization request to include an intelligent estimated amount that may be calculated in real-time. This enhanced intelligent estimated amount may then be provided to the issuer for an authorization decision. The intelligent estimated amount may be a relatively improved estimate because it takes into account information not available to the merchant but related to the transaction.

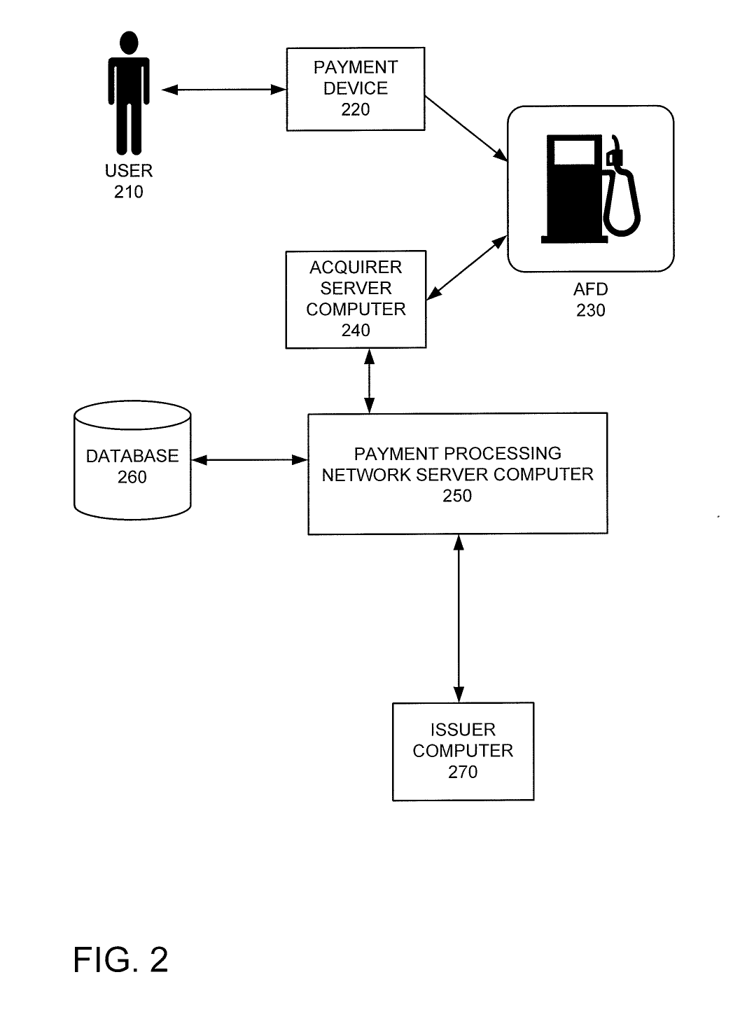

FIG. 2 illustrates an exemplary transaction where an intelligent estimated amount is used in the request for authorization according to an embodiment of the present invention. The transaction illustrated in FIG. 2 includes a user purchasing fuel at an automated fuel dispenser (AFD) typically found at gas stations. A user 210 may use a payment device 220 to purchase fuel at an AFD 230. For example, the user 210 may swipe his/her card and/or enter certain identifying details, such as the zip code associated with the billing address of the card at the AFD 230. The AFD 230 may then communicate with an acquirer server computer 240 to request an authorization for the transaction. In some embodiments, as part of the authorization process, the AFD 230 may indicate to the acquirer that an intelligent estimated amount is to be requested for the transaction.

The acquirer server computer 240 may communicate the request to a payment processing network server computer 250. The payment processing network server computer 250 may consult a database 260 to acquire additional information about the user, merchant, and/or other information related to the transaction. Based on the information received from the database 260, the payment processing network server computer 250 may determine an intelligent estimated amount for the transaction. Thereafter, the payment processing network server computer may communicate the intelligent estimated amount to an issuer computer 270 associated with the issuer of the payment device 220. The issuer computer 270 may send an authorization response message to the payment processing network server computer 250, which may in turn communicate the response to the AFD 230 via the acquirer server computer 240. The response message may either indicate approval of the intelligent estimated amount or denial of the intelligent estimated amount.

In some embodiments, the payment processing network server computer 250 may receive an indication that the merchant is requesting an intelligent estimated amount authorization. The payment processing network server computer 250 may have historical information that is relevant to the payment stored in the database 260. For example, the database may store information on previous payment activity of the cardholder who is conducting the transaction, the merchant's average payment volume for the transaction location, current price indices for the types of goods being purchased (e.g. fuel price), and other related payment activity tied to the cardholder (household and linked accounts).

In some embodiments, payment processing network server computer 250 receives an authorization request from acquirer server computer 240 which includes the indication that the merchant is requesting an intelligent estimated amount authorization. Thereafter using the data in database 260, the payment processing network server computer 250 may determine the intelligent estimated amount. For example, based on statistical models and the external information, the payment processing network server computer 250 may determine an intelligent estimate for the transaction amount. This intelligent estimate may then be inserted into the authorization request that is sent to the issuer.

The authorization request including the intelligent estimated amount is then forwarded to the issuer computer 270 for authorization. Optionally, the issuer computer 270 can also receive an indicator, e.g., via the authorization request, that the authorization amount was generated by the intelligent estimated amount process. The issuer can then make an authorization determination based on the intelligent estimated amount estimate. If the transaction is authorized, an authorization response message may be sent back to the merchant, including the amount that was authorized.

Upon receipt of the authorization response message including the amount that was authorized, the merchant may set the AFD 230 to allow fuel to be dispensed up to the amount that was authorized. In this way, the merchant is protected from charge backs by the issuer for allowing a transaction that exceeds the authorization amount. In addition, because the estimate for the authorization amount was based on a more complete understanding of the user's spending history and account status, and also the merchant's transaction history, in most cases, the intelligent estimated amount will generally be closer to the final transaction amount for the transaction. This may prevent loss of sale for the merchant that may occur due to underestimation of the amount that is likely to happen using current techniques, as discussed above.

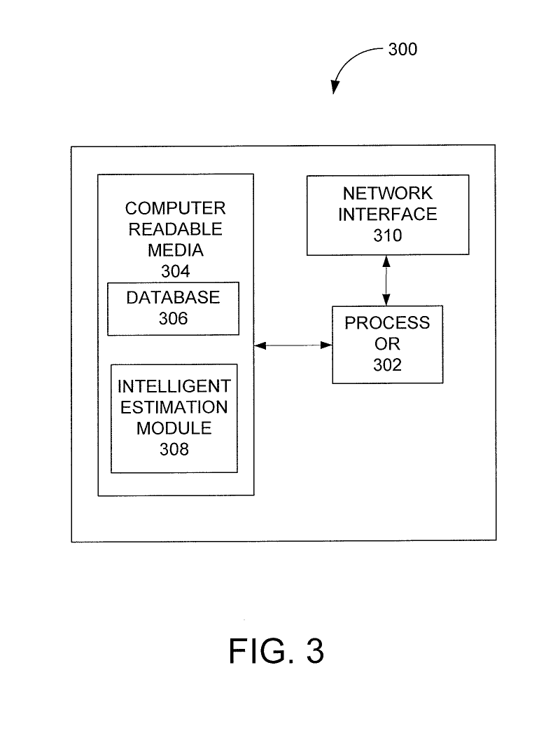

FIG. 3 is a functional block diagram of a payment processing network server computer 300 according to an embodiment of the present invention. As discussed above, the payment processing network can receive a request for providing an intelligent estimated amount from a merchant and in response calculate an estimated amount and send it to the issuer for authorization. The payment processing network server computer 300 may include a processor 302, a network interface 310 and a non-transitory computer readable media 304. Computer readable media 304 may further include a database 306 and an intelligent estimation module 308.

Processor 302, which can be implemented as one or more integrated circuits (including, e.g., a conventional microprocessor or microcontroller), can control the operation of the payment processing network server computer 300. For example, in response to request for generating an intelligent estimated amount, the processor 302 may perform several tasks such as working in conjunction with the database 306 and intelligent estimation module 308 to generate the intelligent estimated amount and communicate the intelligent estimated amount, via an authorization request, to an issuer computer.

Computer-readable media 304 may be implemented, e.g., using disk, flash memory, or any other non-transitory, non-volatile storage medium. The computer-readable media 304 can store application programs that are executable by the processor 302, system programs and other program code (not explicitly shown) that can be used in calculating the intelligent estimated amount. In some embodiments, the computer readable media 304 can include the database 306 and the intelligent estimation module 308.

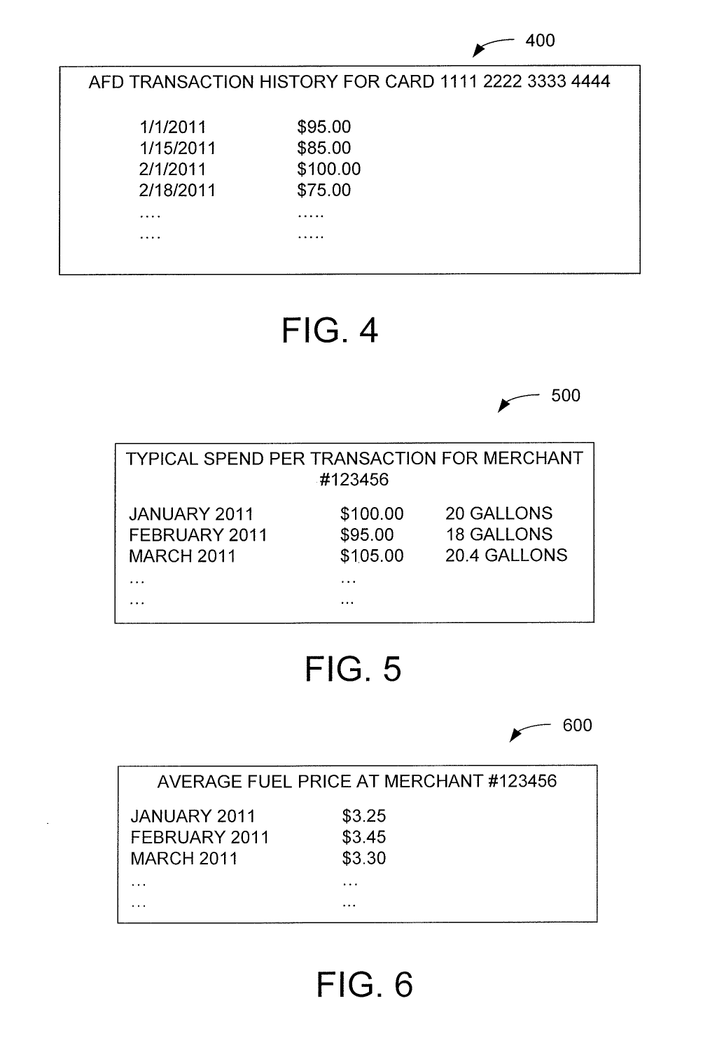

Database 306 can be implemented using hardware and software and may include user and/or merchant related information. For example, the database 306 can include information about how much money the user has spent in a certain month at a particular merchant. Such information can be indexed using the merchant category code (MCC) associated with the merchant and the user's account number or some other unique identifier, e.g., an alias. FIG. 4 illustrates an exemplary table 400 that may be stored in database 306. Table 400 includes information about a particular user account and amount charged to that account number for AFD transactions indexed by dates. Thus, it can be seen that the user spent $95 on Jan. 1, 2011 and $100 on Feb. 1, 2011 for fuel purchase. This information can be used to generate the intelligent estimated amount by server 300. In this instance, if the merchant were to only authorize the standard $75, the merchant would stand to loose between $10 and $25 of extra revenue since the user is likely to pump more than $75 worth of gas based on the past transaction history. This is but only one instance where the payment processing network can help the merchant maximize their revenue.

FIG. 5 illustrates an exemplary table 500 that shows a user's transactions at a particular merchant for the first three months in 2011. As illustrated in FIG. 5, the user's transaction history is indexed using the merchant identifier, e.g., merchant category code. This information can be helpful to the merchant in determining how much the user is likely to spend on his current transaction so that the merchant can maximize the revenue for the user. One skilled in the art will realize that there are many other ways to arrange and store such information.

In some embodiments, the database 306 may store user profile information which can include, e.g., the information illustrated in table 500. In some embodiments, the user profile information may include transaction information associated with each payment account of the user. In some embodiments, the user profile may include transaction information related to each merchant segment with whom the user has had past interactions, e.g., fuel stations, grocery stores, etc. This information can provide a better understanding of the user's spending habits and often may be good indicators of future behavior of the user, which can be useful in determining the intelligent estimated amount for a current transaction. For example, consider that the user has consistently purchased 10-12 gallons of fuel in the past 15 fuel purchase transactions. In this instance, it is likely that the user will purchase between 10-12 gallons of fuel in the current transaction. This information may be helpful in determining the intelligent estimated amount for this transaction. On the other hand, if the past 15 transactions show that the amount of fuel purchase has varied between 2 and 20 gallons, then the system may make a more conservative estimate for the amount of fuel likely to be purchased in the current transaction and/or look for other patterns in the user profile to refine the estimate. In some embodiments, the user profile information may also include information such as information about all the payment devices owned by the user, product type of each of the payment devices, household information for the user, and other relevant information for generating the intelligent estimated amount.

In some embodiments, the database 306 may also store merchant related information. FIG. 6 illustrates exemplary information that can be stored in the database 306. As illustrated in FIG. 6, table 600 indicates the average fuel price at a particular merchant, e.g., a gas station, for the first three months in 2011. One skilled in the art will realize that other merchant related information can also be stored in the database 306. An illustrative types of information that can be stored in database 306 are provided throughout the specification. It is to be noted that this is not meant to be exhaustive listing of all possible types of information and one skilled in the art will realize that other information in addition to the types of information or in lieu of the types of information illustrated in the specification can be stored in the database 306. In some embodiments, the database 306 can be external to server 300 and may be hosted remotely from server 300.

In some embodiments, the database 306 may receive updated information from various external sources. In some embodiments, the specific pricing information for goods/services rendered for a plurality of market segments can be individually maintained in the database 306 and indexed by the merchant category. For example, if the item subject to a transaction is fuel, the database 306 can maintain price information for fuel at various merchant locations. This information can be periodically updated. For example, the database 306 may use fuel information available from US government's Energy Information Administration (e.g., www.eia.gov).

Intelligent estimation module 308 can be implemented as a combination of hardware and software or as a purely software program. In some embodiments, the intelligent estimation module 308 can receive information about the merchant and the user from the database 306 and apply one or more rules/algorithms to the information to generate the intelligent estimated amount. The intelligent estimated amount can then be communicated to the issuer computer via the authorization message. In some embodiments, intelligent estimation module can include the logic/mathematical model that can be used to generate the intelligent estimated amount. In some embodiments, there may be a specific mathematical model/algorithm associated with each merchant category.

In some embodiments, the intelligent estimation module 308 may use one or more the following items of information to calculate the intelligent estimated amount (a) name of the merchant, (b) merchant identifier included in the authorization request, (c) an item or service associated with the transaction, (d) a geographical location of the merchant, (e) an average price for the item or service in the geographical location, (f) a first average amount previously spent by the user for that item or service, (g) a second average amount previously spent by the user for that item or service using the payment device that is also being used in the current transaction, (h) an average amount previously spent by the user in a previous transaction similar to the current transaction, (i) details of an item or service purchased by the user as part of the previous transaction similar to the current transaction, and (j) time period between the current transaction and the previous transaction similar to the current transaction, where the previous transaction immediately precedes the current transaction.

In some embodiments, the intelligent estimation module 308 may use a different algorithm to calculate the intelligent estimated amount based on the merchant category. Thus, in some embodiments, a separate algorithm can be established for each merchant category taking into account the unique aspects for each of the merchant categories. For example, there may be an algorithm for fuel dispensing stations that is different from an algorithm used for hotels and car rental merchants. Thus, it may be possible to customize algorithms for specific merchants and/or merchant categories. In some embodiments, the various algorithms may be indexed using the merchant category code (MCC) in the intelligent estimation module 308.

Network interface 310 can provide an interface to one or more communication networks. For example, the network interface 310 can incorporate a radio-frequency (RF) transceiver and suitable components for communicating via a mobile communication network such as a mobile telephone network. Additionally or instead, the network interface 310 can incorporate a wireless connection to the Internet (e.g., a WiFi transceiver, 3G transceiver or the like), to a personal area network (e.g., a Bluetooth network), or any other network. In still other embodiments, a wired network connection (e.g., Ethernet) may be provided. In some embodiments, the same hardware can be used to support connections to multiple networks; thus, network interface 310 can include analog-to-digital and/or digital-to-analog circuitry, baseband processing components (e.g., codecs, channel estimators, and the like), modulators, demodulators, oscillators, amplifiers, transmitters, receivers, transceivers, internal and/or external antennas, and so on. In some embodiments, some operations associated with network connectivity can be implemented entirely or in part as programs executed on processor 302 (e.g., encoding, decoding, and/or other processing in the digital domain), or a dedicated digital signal processor can be provided.

It will be appreciated that the system configurations and components described herein are illustrative and that variations and modifications are possible. The payment processing network server computer may have other capabilities not specifically described herein. For example, in some embodiments, the payment processing network may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and in some instances performs clearing and a Base II system which performs clearing services in instances where the VIP system does not perform the clearing.

Further, while the payment processing network server computer is described herein with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of devices including electronic devices implemented using any combination of circuitry and software.

In some embodiments, a merchant may have to register with the payment processing network server computer in order to receive the intelligent estimated amount. At the time of registration, the merchant may specify certain parameters associated with determining the intelligent estimated amount. For example, the merchant may specify a default amount to be used to seek authorization in the instances where the intelligent estimated amount cannot be reasonably predicted. This default amount can be the default amount described above, e.g., $75. In some embodiments, the merchant may also specify a surplus amount to be added to the intelligent estimated amount. The surplus amount can be varied periodically or for each transaction. In some embodiments, the merchant may specify the surplus amount to account for additional services or goods that the user may purchase as part of the same transaction. For example, a gas station may want to add $7 to the intelligent estimated amount to account for a car wash that the user may purchase upon being presented with the opportunity. This will eliminate the need for seeking additional authorization should the user choose to buy the car wash and also allow the merchant to offer additional goods/services to the user to increase the merchant's revenue potential.

In some embodiments, the merchant may specify a minimum amount for the intelligent estimated amount. For example, the merchant may want to seek authorization for at least $50 for any fuel transaction in order to ensure that the fuel purchase is adequately covered. In some embodiments, the merchant may specify that the minimum amount may be used for seeking authorization if either the intelligent estimated amount is lower than the minimum amount or if the intelligent estimated amount cannot be determined. In some embodiments, the merchant may also specify a maximum amount for the intelligent estimated amount. The maximum amount represents the ceiling for the intelligent estimated amount. Thus, in this instance, regardless of the calculated intelligent estimated amount, the amount that can be used to seek authorization may not exceed the maximum amount. For example, consider that the maximum amount specified by the merchant is $100 and the intelligent estimated amount calculated by the payment processing network server computer is $125. In this example, the payment processing network server computer can only seek authorization for $100 since that is the maximum amount specified by the merchant. A merchant may specify a maximum amount in order to limit the merchant's exposure to possible chargeback that may occur if the intelligent estimated amount is higher than normal.

In some embodiments, the merchant may also specify a buffer coefficient. In some embodiments, the buffer coefficient can be a numerical value. In other embodiments, the buffer coefficient can be a percentage value. The buffer coefficient value may specify a deviation from the calculated intelligent estimated amount. For example, a buffer coefficient value of 0 (or 0%) indicates that the amount used to seek authorization is exactly equal to the calculated intelligent estimated amount. A positive value for the buffer coefficient informs the payment processing network server computer that it should increase the intelligent estimated amount by the buffer coefficient value and seek authorization for new increased amount. For example, consider that the intelligent estimated amount is $100 and the buffer coefficient value is +5 (or 5%). In this instance, the payment processing network server computer may increase the intelligent estimated amount by $5 and seek authorization for $105 from the corresponding issuer. A negative value for the buffer coefficient informs the payment processing network server computer that the calculated intelligent estimated amount is to be reduced based on the buffer coefficient before seeking authorization. In the above example, if the buffer coefficient value is −5 (or −5%), the amount sent to issuer for authorization may be $95. The buffer coefficient value may be used by the merchant to account for situations that may be unique to the merchant. For example, authorization decline trends at the merchant or other market factors.

Once the merchant registers for the intelligent estimated amount service, the merchant's transaction history can be analyzed to determine certain performance parameters for the merchant that may be used by the payment processing network server computer to determine the intelligent estimate. The performance parameters may vary for each merchant, merchant segment, location, and/or dominant commodity sold. For example, for a merchant who is a fuel vendor, the transaction history may be used to determine average payment amount for each fuel transaction at that merchant. This average amount can then be used as an input when calculating the intelligent estimated amount or can be used to perform a sanity check on the calculated intelligent estimated amount. In some embodiments, these performance parameters can be used to ensure that the intelligent estimated amount is within a certain threshold of the performance parameters. If the intelligent estimated amount has a large deviation from these performance parameters, the intelligent estimated amount may be recalculated using different input values.

### Specific Embodiment

### Transactions Involving Automated Fuel Dispenser Purchases

Next, we will describe how an intelligent estimated amount is calculated for a transaction involving purchasing fuel using an automated fuel dispenser. It is to be noted that the embodiment described below if for illustration purposes only and is not intended to limit the scope of the invention in any manner.

In the instance where the transaction is a fuel purchase transaction, the payment processing network server computer may use information about one or more of: a type of fuel previously purchased by a user, a location for the fuel purchase transaction, a current price of the type of fuel based on the location, an average amount of the type of fuel purchased by the user in one or more previous transactions, an account balance associated with the payment device, the type of fuel being requested, and the current price for the type of fuel to determine the intelligent estimated amount.

In some embodiments, the payment processing network server computer may communicate with one or more external systems to gather and update the information that is used for determining the intelligent estimated amount. For example, the payment processing network server computer may communicate with any known system that provides nationwide fuel price information, which is updated periodically. In some embodiments, the payment processing network server computer may use the latitude and longitude information or GPS information to determine location of the AFD and/or the user when he initiates the transaction. Other historical information about average fuel prices, etc. can also be procured from external service providers or directly from the merchants. Since the payment processing network server computer processes payment transactions for the user's accounts, it may already possess the account and transaction information for the user accounts.

In some embodiments, in addition to or in lieu of the items of information described above, the intelligent estimation module 308 may also use one or more of the following items of information to determine the intelligent estimated amount. The information that may be used can include (1) a type of fuel usually purchased by the user using the payment device being used in the current transaction, (2) a current price for the type of fuel usually purchased by the user, (3) an average amount (e.g., in gallons or $) of the type of fuel purchased by the user in one or more previous transactions, and (4) account balance associated with the payment device being used for the current transaction.

### Authorization Request Message

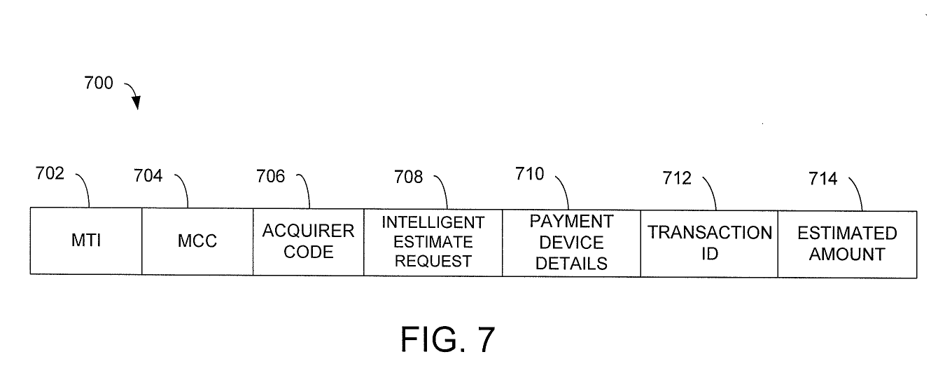

As discussed above, the payment processing network server computer receives an authorization request message from the merchant acquirer. In some embodiments, the authorization message may include an indication that the merchant is requesting an intelligent estimate to be generated. FIG. 7 illustrates an authorization request message 700 according to an embodiment of the present invention.

Authorization message or message 700 can include multiple fields of information. In some embodiments, the authorization message 700 can include a message type indicator (MTI) field 702. The MTI 702 may indicate to the payment processing network server computer that the message 700 is an authorization message. In other words, the MTI 702 is used to indicate the type of message associated with the message 700. The message 700 can also include a merchant verification value (MVV) 704. The MVV 704 is a unique identifier associated with a merchant. The MVV 704 informs the payment processing network server computer about the merchant that has requested the authorization. In some embodiments, the MVV 704 can also be used by the payment processing network server computer to query a database to request the merchant specific information or transaction information between the merchant and a specific user, as discussed above. The message 700 can further include an acquirer code 706, which is associated with the acquirer of the merchant identified by the MVV 704. In some embodiments, the acquirer code can be a unique identifier associated with the financial institution with whom the merchant has contracted to process its payment transactions.

The message 700 may also include an intelligent estimate request field 708. The intelligent estimate request field 708 can be used to indicate to the payment processing network that the merchant is requesting that an intelligent estimated amount be calculated for the transaction. In some embodiments, the intelligent estimate request field 708 can accommodate alphanumeric value encoded in the tag-length-value format known in the art. In sum, the intelligent estimate request field 708 can be used to indicate whether the merchant is requesting an intelligent estimated amount. For example, a “1” or “yes' in the intelligent estimate request field 708 may indicate to the payment processing network server computer that the merchant is requesting an intelligent estimated amount for the corresponding transaction.

In some embodiments, the intelligent estimate request field 708 may also include additional data that may be used by the payment processing network server computer to determine the intelligent estimated amount. For example, if the transaction includes paying for a hotel stay, the additional data may include the anticipated number of nights of stay. For a car rental transaction, the additional data may include number of days of rental, etc. This may further help to refine the intelligent estimated amount for each transaction.

The message 700 may also include payment device details 710, which may include a payment account number, e.g., PAN, or alias information associated with the payment device. As discussed above, a payment device can include a credit card, a debit card, a smart card, a mobile device, etc. The message 700 may further include a transaction ID 712 that may be used to keep track of the transaction as it propagates through the various steps of payment processing. In some embodiments, the message 700 may also include the estimated amount 714. For instance, the payment processing network server computer may populate the estimated amount 714 with a $ amount once it generates the intelligent estimated amount. In other embodiments, the merchant may populate the estimated amount 714 before sending the message 700 to the payment processing network server computer. Several different scenarios for populating the estimate amount field 714 are possible.

In a first instance, the merchant can request calculation of an estimated amount, e.g., using field 708, and leave the estimated amount 714 empty when sending message 700 to the payment processing network server computer. In this scenario, the payment processing network server computer can calculate an estimated amount as discussed above and insert the calculated amount into field 714 before forwarding message 700 to an issuer computer. In a second instance, the merchant can indicate that it does not require an estimated amount to be calculated, e.g., by setting field 708 to “0”, and insert an amount in field 714 before sending message 700 to the payment processing network server computer. In this instance, the payment processing network server computer will forward the message 700 to the issuer computer without modifying field 714. In a third scenario, the merchant may indicate that it is requesting an intelligent estimated amount but may also populate field 714 with an amount. In this scenario, the payment processing network server computer may replace the amount provided by the merchant with the newly calculated estimated amount. In a fourth scenario, the merchant may indicate that is does not wish to request an intelligent estimate but also may leave the field 714 empty. In this instance, the payment processing network server computer may populate the field with a default amount and send message 700 to the issuer.

It is to be noted that the authorization message 700 described above is for illustration purposes only. In some embodiments, the authorization message 700 may include more or less information than indicated in FIG. 7. For instance, In some embodiments, the message 700 may also include a merchant category code (MCC) field associated with the category of the merchant. The MCC is a unique identifier that informs the payment processing network server computer that merchant belongs to a certain category. One skilled in the art will realize many modifications.

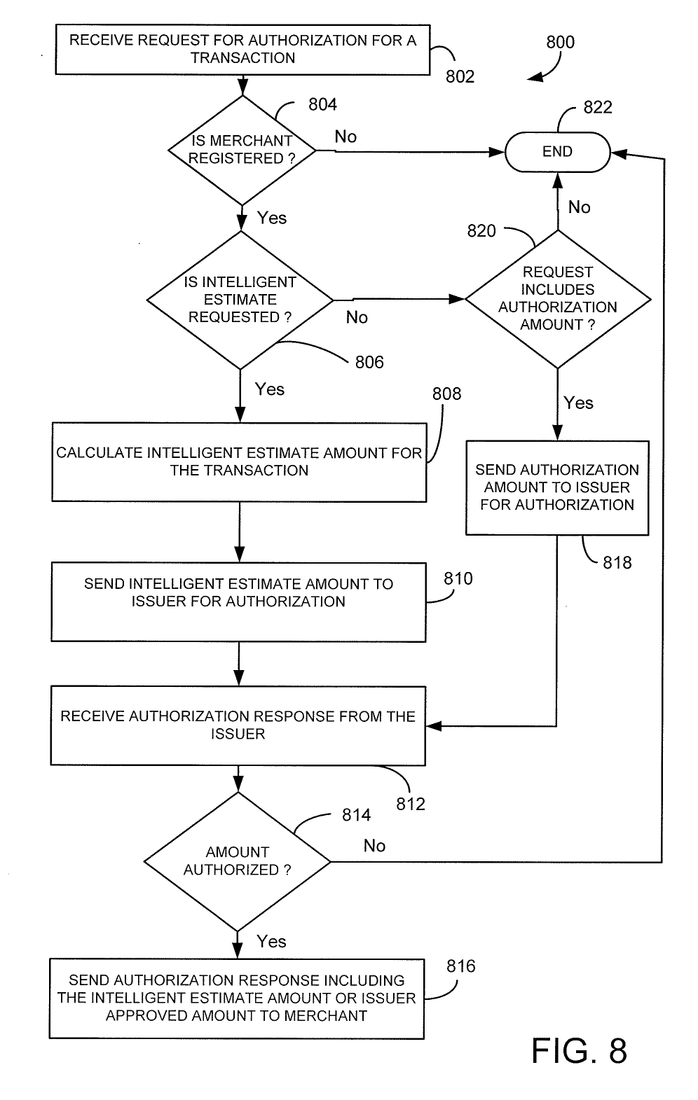

FIG. 8 is a flow diagram of a process 800 for providing intelligent estimated amount according to an embodiment of the present invention. Process 800 can be performed, e.g., by the payment processing network server computer 300 of FIG. 3.

A user may request to purchase a product or service from merchant where the final amount of the transaction may not be known. In this instance, the merchant can request authorization for a certain amount for the issuer of the user's payment device. In order to request the authorization, the merchant can send an authorization request message to a payment processing network server computer. The payment processing network server computer can receive the authorization request message (step 802). Upon receiving the authorization request message, the payment processing network server computer can determine whether the merchant is registered to receive the intelligent estimated amount, e.g., using the MVV described above (step 804). In some embodiments, the merchant acquirer BIN or a direct connect processor ID may be used to determine whether the merchant is registered to receive the intelligent estimated amount. If the merchant is not registered to receive the intelligent estimated amount, process 800 can end at step 822. If it is determined that the merchant is registered to receive the intelligent estimated amount, the payment processing network server computer can check the authorization request message to determine whether the merchant has requested that an intelligent estimated amount be determined for the current transaction (step 806), e.g., using field 708 of FIG. 7. If the payment processing network server computer determines that the merchant is not requesting an intelligent estimated amount, the payment processing network server computer may check the authorization request message to determine whether the merchant has included a requested amount, e.g., in field 714 of FIG. 7 (step 820). If there is no requested amount included in the authorization request message, the process may end (step 822). If a requested amount is included by the merchant in the authorization request message, the payment processing network server computer can forward the authorization request message including the merchant-provided requested amount to the issuer (step 818).

If at step 806 it is determined that the merchant is requesting an intelligent estimated amount to be calculated, the payment processing network server computer can calculate the intelligent estimated amount (step 808) as discussed above. Thereafter, the payment processing network server computer may include the calculated intelligent estimated amount in the authorization request message, e.g., at field 714 of FIG. 7, and send the authorization request message to an issuer (step 810). The payment processing network server computer may receive an authorization response message from the issuer (step 812). The authorization message response may either indicate approval of the intelligent estimated amount or denial of the intelligent estimated amount (step 814). If the request intelligent estimated amount is authorized by the issuer, the payment processing network may send a response to the merchant indicating approval of the intelligent estimated amount and include the intelligent estimated amount in the response (step 816). If the requested intelligent estimated amount is denied by the issuer, process 800 can end (step 822).

It will be appreciated that process 800 described herein is illustrative and that variations and modifications are possible. Acts described as sequential can be executed in parallel, order of acts can be varied, and acts can be modified or combined. For instance, after the payment processing network determines that no amount is requested by the merchant in the authorization request message at step 818, the payment processing network server computer may insert a default amount in the authorization request message and forward the authorization request message to the issuer instead of ending process 800. In some embodiments, after determining that the merchant is requesting an intelligent estimated amount at step 806, the payment processing network server computer can determine an algorithm to be used for calculating the intelligent estimated amount, e.g., using the MCC included in the authorization request message.

It is to be noted that the issuer is not obligated to authorize only the intelligent estimated amount. In some embodiments, the issuer can authorize an amount that is higher or lower than the intelligent estimated amount. Thus, in some instances, the intelligent estimated amount may be used a guideline rather than as the only amount that has to be approved or denied.

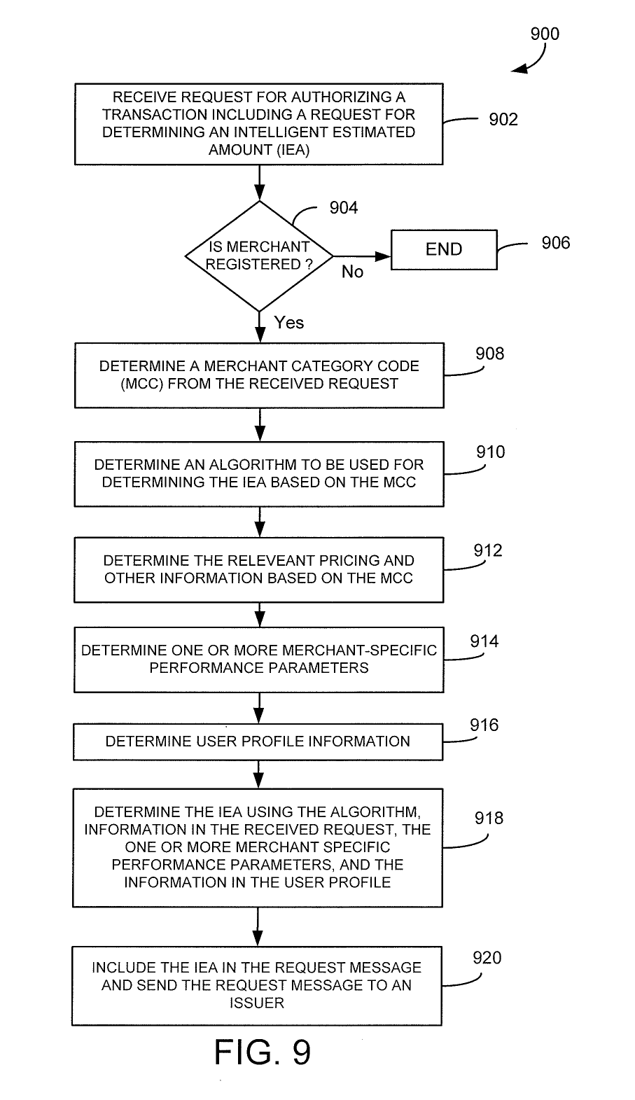

FIG. 9 is a flow diagram of a process 900 for determining intelligent estimated amount according to another embodiment of the present invention. Process 900 can be performed, e.g., by the payment processing network server computer 300 of FIG. 3.

The payment processing network server computer may receive a authorization request for authorizing transaction from a merchant computer associated with a merchant. The authorization request may include an indication that the merchant is requesting an intelligent estimated amount to be determined for this transaction (step 902). The payment processing network server computer may determine whether the merchant is registered to use the intelligent estimated amount service, e.g., as described above in merchant registration (step 904). If the merchant is not registered for using the service, the payment processing network may send a message to the merchant informing him that this service is not available for the merchant and optionally requesting the merchant to subscribe to the service and process 900 may end at step 906 in this instance.

If the merchant is registered to use the service, the payment processing network server computer can then determine a merchant category code (MCC) from the received authorization request (step 908). Based on the MCC, the payment processing network server computer can then determine an appropriate algorithm to use for determining the intelligent estimated amount (step 910). As described above, each merchant category can have an associated algorithm for determining the intelligent estimated amount. Based on the MCC, the payment processing network server computer can then determine the latest pricing information and other information related to the transaction, e.g., information in tables 500 and 600 of FIGS. 5 and 6, respectively (step 912). The payment processing network server computer can then determine one or more merchant-specific performance parameters, described above, associated with the merchant, e.g., from database 306 of FIG. 3, (step 914). In some embodiments, the payment processing network server computer may use the MVV associated with the merchant to determine the performance parameters. The payment processing network server computer may then determine user profile information, e.g., from database 306 of FIG. 3. (step 916). The user profile information may include information related to the user's payment account that is being used to conduct the current transaction, e.g., as shown in table 400 of FIG. 4. In some embodiments, the user profile information may be obtained using the payment account number or PAN of the payment device being used in the current transaction.

Thereafter, the payment processing network server computer may use the information determined in steps 910-916 as inputs to the algorithm determined in step 908 and compute the intelligent estimated amount (step 918). Once computed, the payment processing network server computer can include the intelligent estimated amount in the authorization request and forward the authorization request to the appropriate issuer (step 920).

It will be appreciated that process 900 described herein is illustrative and that variations and modifications are possible. Acts described as sequential can be executed in parallel, order of acts can be varied, and acts can be modified or combined. For instance, the payment processing network server computer may also determine whether the issuer is capable of receiving information related to the intelligent estimated amount and if yes, the payment processing network server computer may provide an indication to the issuer, e.g., using the authorization request message, that the authorization amount in the authorization request message is an intelligent estimated amount. This may provide the issuer with an assurance that the amount is not arbitrarily determined and that the amount is likely to be closer to the actual final amount of the transaction. This may simplify the issuer's decision on whether to approve or deny the requested amount.

In some embodiments, prior to step 920, the payment processing network server computer may add the surplus amount to the intelligent estimated amount and then include the total amount in the authorization request message sent to the issuer. In some embodiments, in addition to the surplus amount or in lieu of the surplus amount, the payment processing network server computer may apply the buffer coefficient discussed above to the intelligent estimated amount prior to sending the resultant total amount to the issuer for authorization. In some embodiments, once the intelligent estimated amount (or the total amount) is calculated, the payment processing network server computer may determine whether the intelligent estimated amount is within the window defined by the minimum amount and maximum amount specified by the merchant. Based on the determination, the intelligent estimated amount sent to the issuer may be adjusted up or down to be within the window.

Although several factors for establishing an intelligent estimated amount have been described above, it should be understood that these factors are not intended to be exhaustive. What should be understood is that the payment processing network, working in conjunction with historical transaction information as well as external non-transaction related information can determine an intelligent estimated amount for authorization in a particular transaction.

The embodiments above have been described where the payment processing network that processes the transaction also determines the intelligent estimated amount. In an alternate embodiment, the intelligent estimated amount may not be calculated by the payment processing network. For example, the intelligent estimated amount may be determined by a third party service provider. For example, the merchant computer, prior to sending the authorization request message to the payment processing network server computer, may communicate with an intelligent estimated amount generation system. The intelligent estimated amount generation system may then provide an intelligent estimated amount for the transaction to the merchant computer. The merchant computer may then insert the received intelligent estimated amount in the authorization request message prior to sending the authorization request message to the payment processing network via the merchant acquirer.

As such, the intelligent estimated amount generation system may no longer be dependent on the payment processing network server computer to provide the intelligent estimated amount. This can be useful in cases where the transaction will not be processed by a particular payment processing network. Furthermore, in such an instance, the intelligent estimated amount generation system may receive requests from all of a particular user's accounts, not just the ones branded with the payment processing network. For example, a user may hold payment devices for use with VISA®, MASTERCARD® and DISCOVER® processing systems. In this instance, the intelligent estimated amount generation system can receive requests for an intelligent estimated amount request regardless of which payment device is being used. Thus the intelligent estimated amount generation system can develop a broader profile of a user that can span across all of the user's accounts, regardless of issuer or payment processing network.

In some embodiments, the issuer has complete discretion on whether to approve the intelligent estimated amount. For instance, the issuer may authorize a lesser amount than the intelligent estimated amount provided by the payment processing network based on other considerations and verification that an issuer may perform. Thus, the intelligent estimated amount is not binding on the issuer, however, given the process used in arriving at the intelligent estimated amount, it is likely that the issuer will defer to that amount instead of performing additional analysis of its own. In some embodiments, the rules for determining the intelligent estimated amount can incorporate rules specified by the issuers. This can accomplish at least two things. First, it will provide assurance to the issuer that the calculated estimated amount is likely to be closer to the actual amount and second, it will free up the issuer's resources by relieving the issuer of the computation intensive task of determining whether the current merchant-requested amount should be approved.

As discussed above, in some embodiments, the issuer may be given more control over the amount to be authorized. Currently, a merchant can specify a specific amount as his authorization amount, which is then sent to the issuer for authorization. Since the merchant is not privy to the user's history and his account status, this process can result in an unusually large number of declines from the issuer since. Furthermore, the issuer in this case may not have flexibility in authorizing amounts other than the merchant-specified amount. Such declines by the issuer can result in loss of business for the merchant and also cause frustration to the user. Some embodiments of the present invention provide techniques in which the issuer has more control over the amount to be authorized based on a default amount specified by the payment processing network.

In some embodiments, instead of the merchant determining and specifying an amount for a transaction, the merchant may simple ask for $1 authorization for every transaction. In this instance, the issuer may interpret the $1 to imply a default amount agreed between the payment processing network and the issuer. After receipt of the request for authorization, the issuer can verify the user's account history, its own risk tolerance, product type, account balance, and other factors to determine whether it wants to authorize the default amount provided by the payment processing network. In some embodiments, the issuer may approve the default amount. In other embodiments, the issuer may approve any amount less than the default amount based on its evaluation of the user account. For example, accounts in good standing with a good history can be approved for the default amount while accounts with delinquency or poor payment history can be approved for an amount less than the default amount. In some embodiments, the default amount can be changed periodically based on market conditions and other relevant factors.

Although the description above uses AFD-based fuel purchase transactions to describe the various embodiments of the present invention, it should be understood that embodiments of the present invention are not so limited. Embodiments described herein are applicable for any transaction where the final transaction amount is not available at the time of initial authorization. For example, at a restaurant, in many instances the final amount including tip is not usually known when the transaction is first authorized. Embodiments of the disclosure could be used to intelligently estimate a users tipping habits, such that the authorization amount includes the users usual tip. Embodiments of the disclosure would be applicable in other situations such as when the final amount of a rental car transaction is not known at the time of initial authorization. In this case, the user's as well as the merchant's transaction history may be used to develop an intelligent estimate. Other examples include hotels or any number of other situations where the final transaction price is not known at the time of authorization.

Many advantages can be realized by use of the techniques described herein. From a user's perspective, having an estimated amount predicted using multiple factors described above will result in only the needed amount being held on his payment device. This will enable the user to use his payment device for other purposes while the transaction is in progress without getting denied for his other transactions. For example, consider that the user is travelling for business and provides his credit card at hotel check-in. Without the use of an intelligent estimated amount as described above, the hotel may request authorization for an unduly large amount to lower their risk of chargeback. In this situation, the user may get his credit card denied at another location, e.g., at a business dinner, because the hotel used up the remaining credit balance on his card by requesting an arbitrarily large amount for authorization.

From the merchant's perspective, having the authorization amount intelligently estimated will ensure that he can maximize his revenue and at the same time avoid denials or chargebacks due to arbitrarily determined authorization amounts.

From the issuer's perspective, the techniques described above limit their exposure on each of the accounts since they can feel confident that the user is going to spend the authorized amount and that the authorized amount is closer to what the actual amount will likely be for the transaction. Also, this will result in less chargebacks that they have to process that will result in less merchant frustration.

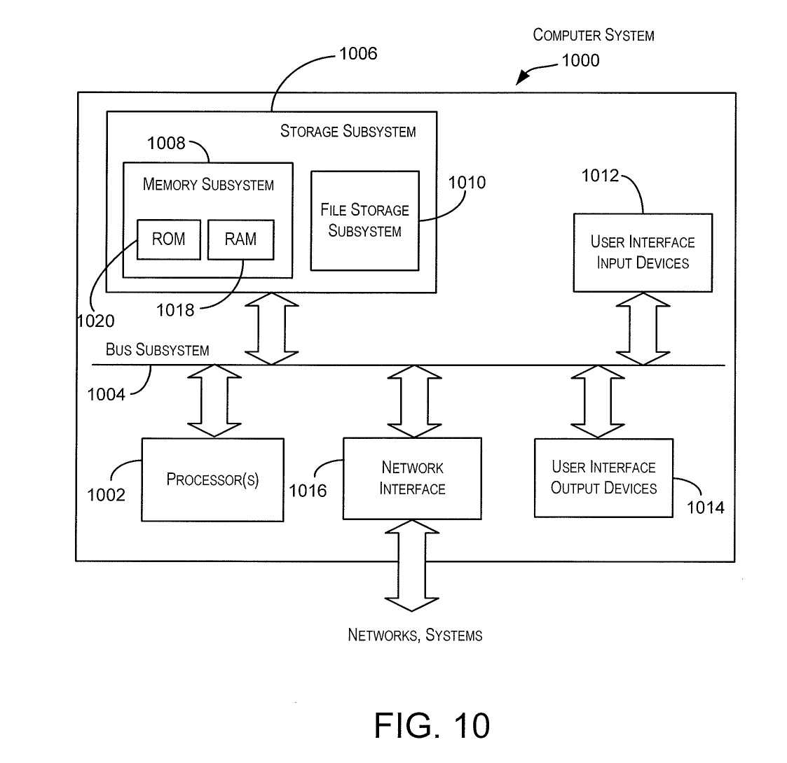

FIG. 10 is a simplified block diagram of a computer system 1000 that may be used to practice an embodiment of the present invention. The various entities described in this specification and in the figures may operate or use one or more computer apparatuses to facilitate the functions described herein. Any of the elements in FIG. 2 (e.g., AFD 230, acquirer 240, Transaction Processing Network 250, and Issuer 270, etc.) may use any suitable number of subsystems to facilitate the functions described herein. Examples of such subsystems or components are shown in FIG. 10. As shown in FIG. 10, computer system 1000 includes a processor 1002 that communicates with a number of peripheral subsystems via a bus subsystem 1004. These peripheral subsystems may include a storage subsystem 1006, comprising a memory subsystem 1008 and a file storage subsystem 1010, user interface input devices 1012, user interface output devices 1014, and a network interface subsystem 1016.

Bus subsystem 1004 provides a mechanism for enabling the various components and subsystems of computer system 1000 to communicate with each other as intended. Although bus subsystem 1004 is shown schematically as a single bus, alternative embodiments of the bus subsystem may utilize multiple busses.

Network interface subsystem 1016 provides an interface to other computer systems and networks. Network interface subsystem 1016 serves as an interface for receiving data from and transmitting data to other systems from computer system 1000. For example, network interface subsystem 1016 may enable a user computer to connect to the Internet and facilitate communications using the Internet.

User interface input devices 1012 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 1000.

User interface output devices 1014 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 1000.

Storage subsystem 1006 provides a computer-readable storage medium for storing the basic programming and data constructs that provide the functionality of the present invention. Software (programs, code modules, instructions) that when executed by a processor provide the functionality of the present invention may be stored in storage subsystem 1006. These software modules or instructions may be executed by processor(s) 1002. Storage subsystem 1006 may also provide a repository for storing data used in accordance with the present invention. Storage subsystem 1006 may comprise memory subsystem 1008 and file/disk storage subsystem 1010.

Memory subsystem 1008 may include a number of memories including a main random access memory (RAM) 1018 for storage of instructions and data during program execution and a read only memory (ROM) 1020 in which fixed instructions are stored. File storage subsystem 1010 provides a non-transitory persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 1000 can be of various types including a personal computer, a portable computer, a workstation, a network computer, a mainframe, a kiosk, a server or any other data processing system. Due to the ever-changing nature of computers and networks, the description of computer system 1000 depicted in FIG. 10 is intended only as a specific example for purposes of illustrating the preferred embodiment of the computer system. Many other configurations having more or fewer components than the system depicted in FIG. 10 are possible.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A computer server comprising:
a processor; and
a memory coupled with the processor;
wherein the processor is configured to:
receive, from a merchant computer associated with a merchant, an authorization request message for a transaction where a final amount associated with the transaction is not known, wherein the authorization request message comprises information about a payment device and a request to calculate an estimated amount for the transaction;
determine the estimated amount for the transaction based at least in part on the information about the payment device and one or more items of information related to the transaction;
include the estimated amount in the authorization request message; and
communicate the authorization request message including the estimated amount to an issuer computer.

2. The computer server of claim 1, wherein the processor is further configured to:
receive an authorization response message from the issuer computer indicative of whether the estimated amount was approved or denied; and
communicate the authorization response message to the merchant computer if the estimated amount is approved, wherein the authorization response message includes the estimated amount.

3. The computer server of claim 1, wherein the one or more items of information related to the transaction comprise one or more of an average amount spent using the payment device at the merchant, location of the merchant, average price of an item or service that is subject of the transaction, type of the item or service, or amount of money spent previously by a user associated with the payment device for purchase of the type of item or service.

4. The computer server of claim 1, wherein the transaction comprises fuel purchase.

5. The computer server of claim 4, wherein the processor is further configured to:
determine a type of fuel previously purchased by a user;
determine a location for the fuel purchase transaction;
determine a current price of the type of fuel based on the location;
determine an average amount of the type of fuel purchased by the user in one or more previous transactions;
determine an account balance associated with the payment device; and
determine the estimated amount based at least in part on the type of fuel, the location, the current price, and the average amount.

6. The computer server of claim 1, wherein the transaction comprises paying for a hotel stay.

7. A method comprising:
receiving, by a server computer, from a merchant computer, a request for authorizing a transaction, wherein a final amount associated with the transaction is not known and wherein the request includes:
information about a payment device being used for the transaction;
information about the merchant associated with the merchant computer; and
a request to calculate an estimated amount for the transaction;
determining, by the server computer, the estimated amount for the transaction based at least in part on the information about the payment device and the information about the merchant;
communicating, by the server computer, the estimated amount to an issuer computer for authorization;
receiving, by the server computer, an authorization response from the issuer, the authorization response indicative of whether the estimated amount was approved or denied; and
sending, by the server computer, the authorization response including the estimated amount to the merchant computer if the estimated amount is approved.

8. The method of claim 7, wherein determining the estimated amount comprises determining one or more attributes associated with a user of the payment device and using the one or more attributes to determine the estimated amount.

9. The method of claim 8, wherein the one or more attributes comprise:
an average amount previously spent by the user for a previous transaction similar to the transaction;
details of an item or service purchased by the user as part of the previous transaction similar to the transaction; and
time period between the transaction and the previous transaction similar to the transaction, wherein the previous transaction immediately precedes the transaction.

10. The method of claim 7, wherein the transaction comprises purchasing fuel using an automated fuel dispenser.

11. The method of claim 10, wherein the estimated amount is based at least in part on past transactions using one or more automated fuel dispensers.

12. The method of claim 10, wherein determining the estimated amount for the transaction further comprises:
analyzing, by the server computer, a merchant identifier associated with a merchant operating the automated fuel dispenser to determine the name of the merchant;
determining, by the server computer, a geographical location of the automated fuel dispenser;
determining, by the server computer, a type of fuel most frequently purchased using the payment device;
determining, by the server computer, a current price for the type of fuel;
determining, by the server computer, an average amount of fuel purchased in each of a plurality of previous transactions using one or more automated fuel dispensers; and
determining, by the server computer, the estimated amount based at least in part on the name of the merchant, the geographical location of the automated fuel dispenser, the type of fuel, the current price for the type of fuel, and the average amount of fuel purchased in a previous transaction.

13. A non-transitory computer readable medium including a plurality of instructions for controlling a processor to determine an estimated amount for a transaction, the plurality of instructions comprising:
instructions that cause the processor to receive an authorization request for the transaction from a merchant computer, the authorization request including information about the transaction and an indication for estimating an amount for the transaction, wherein a final amount for the transaction is not known at the time of receipt of the authorization request;
instructions that cause the processor to determine an estimated amount for the transaction based at least in part on the information included in the authorization request and one or more items of information related to the transaction;
instructions that cause the processor to send the estimated amount to an issuer computer for authorization;
instructions that cause the processor to receive an authorization response message from the issuer computer indicating whether the estimated amount was approved or denied; and
instructions that cause the processor to communicate approval of the authorization request to the merchant computer if the estimated amount is approved.

14. The computer readable medium of claim 13, wherein the authorization request comprises information about a payment device being used by a user for the transaction.

15. The computer readable medium of claim 13, wherein the plurality of instructions further comprise:
instructions that cause the processor to determine the merchant based on a merchant identifier included in the authorization request;
instructions that cause the processor to determine an item or service associated with the transaction;
instructions that cause the processor to determine a geographical location of the merchant;
instructions that cause the processor to determine an average price for the item or service in the geographical location;
instructions that cause the processor to determine a first average amount previously spent by the user for the item or the service;
instructions that cause the processor to determine a second average amount previously spent by the user for the item or the service using the payment device; and
instructions that cause the processor to determine the estimated amount based at least in part on the geographical location of the merchant, the average price for the item or the service in the geographical location, the first average amount, and the second average amount.

16. The computer readable medium of claim 13, wherein the transaction comprises purchasing fuel at an automated fuel dispenser.

17. The computer readable medium of claim 16, wherein the plurality of instructions further comprise:
instructions that cause the processor to determine location of the automated fuel dispenser;
instructions that cause the processor to determine a type of fuel usually purchased by a user of a payment device being used for the transaction;
instructions that cause the processor to determine a current price for the type of fuel;
instructions that cause the processor to determine an average amount of the type of fuel purchased by the user in one or more previous transactions;
instructions that cause the processor to determine an account balance associated with a payment device being used for the transaction; and
instructions that cause the processor to determine the estimated amount based at least in part on the location of the automated fuel dispenser, the type of fuel, the current price for the type of fuel, the average amount of the type of fuel purchased by the user, and the account balance.

18. A method comprising:
receiving, by an issuer computer, an authorization request from a payment processing network server computer, the authorization request including user payment account information and a first amount for which authorization is requested;
determining, by the issuer computer, whether to approve or deny the authorization request based on analysis of the user payment account information, wherein the analysis comprises one or more of:
determining a current status of the user payment account;
analyzing account history of the user payment account; and
determining a current credit balance for the user payment account; and
sending, by the issuer computer, an authorization response message to the payment processing network server computer indicating approval of the authorization request and including a second amount that was authorized.

19. The method of claim 18 wherein the second amount is same as the first amount.

20. The method of claim 18 wherein the authorization request originates from a merchant computer and includes a third amount specified by a merchant associated with the merchant computer.

21. The method of claim 20 wherein the third amount is different from the first amount.

22. The method of claim 20 wherein the third amount is replaced by the first amount before the authorization request message is received by the issuer computer.

23. A method comprising:
(a) receiving, by a payment processing network server computer from a merchant computer associated with a merchant, an authorization request for authorizing a transaction, wherein the authorization request does not include an amount associated with the transaction and includes an indication for determining an intelligent estimated amount for the transaction;
(b) determining, by the payment processing network server computer, that the merchant is registered to request the intelligent estimated amount;
(c) determining, by the payment processing network server computer, an algorithm to be used for determining the intelligent estimated amount based at least in part on a merchant category code (MCC) associated with the merchant, wherein the MCC is included in the authorization request;
(d) determining, by the payment processing network server computer, one or more performance parameters associated with the merchant;
(e) determining, by the payment processing network server computer, pricing information related to the item that is subject of the transaction;
(f) determining, by the payment processing network server computer, information related to one or more previous transactions associated with a user payment account number included in the authorization request;
(g) determining, by the payment processing network server computer, the intelligent estimated amount using information determined in steps (c)-(f);
(h) including, by the payment processing network server computer, the intelligent estimated amount as the transaction amount in the authorization request; and
(i) sending, by the payment processing network server computer, the authorization request to an issuer computer.

24. The method of claim 23 further comprising:
including, by the payment processing network server computer, an indication in the authorization message that the transaction amount is the intelligent estimated amount.

25. The method of claim 23 wherein the one or more performance parameters associated with the merchant are determined using a merchant verification value (MVV) associated with the merchant.

26. The method of claim 23 wherein the one or more performance parameters associated with the merchant include an average transaction amount for the merchant, type of items sold by the merchant, or average price for an item subject to the transaction.
